(19) United States
(12) Patent Application Publication
(10) Pub. No.: US 2017/0032390 A1
(43) Pub. Date: Feb. 2, 2017

(54) SYSTEMS AND METHODS FOR IDENTIFYING A REGION OF INTEREST ON A MAP

(71) Applicant: FRACT, INC., San Francisco, CA (US)

(72) Inventors: Michael MACK, San Francisco, CA (US); Kateryna SYTNYK, San Francisco, CA (US)

(21) Appl. No.: 15/303,222

(22) PCT Filed: Apr. 10, 2015
(86) PCT No.: PCT/US2015/025216

§ 371 Date: Oct. 10, 2016

Related U.S. Application Data
(60) Provisional application No. 61/978,191, filed on Apr. 10, 2014.

(51) Int. Cl. G06Q 30/02; G06T 3/40; G06T 11/20; G06F 17/30; G06T 7/00

(52) U.S. Cl. CPC G06Q 30/0201; G06F 17/30241; G06T 7/0004; G06T 7/0081; G06T 11/20; G06T 3/40; G06T 2207/20112; G06T 2207/30108; G06T 2200/24; G06T 2207/20104; G06F 3/0482

(57) ABSTRACT

A method and system for producing a map and identifying a region of interest is described. In general, the map is tiled with cells each having an associated cell value, and the region of interest in an aggregate, wherein the inventive method and system provide a contiguous region where the sum of the cell values is approximately equal to a user-specified target value. The method and system may thus be use to generate maps highlighting contiguous regions, which may be, for example and without limitation, a sales region, or which may be used to select locations for retail establishments.

### RELATED APPLICATION

The application claims priority from U.S. Provisional Application having Ser. No. 61/978,191, filed on Apr. 10, 2014, which is incorporated herein by reference for all purposes.

### FIELD OF THE INVENTION

The present teachings generally relate to the incorporation of data into a map, and more particularly to generating maps that highlight areas of interest based on map-related data.

### BACKGROUND OF THE INVENTION

One method of presenting geographically related information is to incorporate the information into a pictorial representation of a geographical area. Thus, for example, a geographic information system (GIS) can be used to generate a color-coded map of census data to effectively show the distribution of age, gender, or income across a mapped area. While such maps are useful in providing answers to certain types of questions, such as “what is the distribution of people under 25 in a city,” they are limited in answering questions related to data correlations or determining area-wide questions.

Specifically, some questions to be answered involve aggregates of the information (that is, they require determining regions that satisfy an aggregate target value). Thus, for example, sales regions may be generated using sales data by identifying a contiguous area where the aggregate of the sales data in that area equal some target value. Such a sales area is not easily identifiable from a GIS map of sales data for the mapped area. There are many problems of this type that require information processing in multi-dimensional space to provide an aggregate answer, including problems not related to a physical geography.

Another question that is not easily answered from a GIS map is a solution to the problem of where to place a new retail location in some area to maximize profits. Answering such questions require analyzing the distribution of potential customers about potential retail locations, and may also include incorporating an understanding of public transportation and traffic for the mapped region. Clearly, standard GIS maps of data do not provide solutions to this type of problem. What is needed is the ability to determine regions within a mapped area that meet an aggregate target.

### SUMMARY OF THE INVENTION

In view of the foregoing, one aspect of the present teachings provides a method for identifying a region of interest on a map. In one embodiment, the method for producing a map of a mapped region and a target region of interest, said method comprises: (i) receiving, in the memory of an electronic device, information to define a plurality of cells that form the mapped region and a cell value of a plurality of cells, a target value, and the identification of one or more initial cells; (ii) determining, in a processor of the electronic device, a first region, where the first region is contiguous and includes each of the one or more initial cells; (iii) iteratively enlarging the first region to form a target region by including first-region-adjacent cells to the first region until the sum of the cell values of the first region is equal to or greater than the target value; and (iv) providing at least a portion of the mapped region and the target region to a display of the electronic device. In one embodiment, the target region is a sales territory region.

In certain embodiments, receiving includes receiving a criteria value; and iteratively enlarging the region to form a target region includes: (i) selecting one or more cells adjacent to the region and having a cell value greater than the criteria value; (ii) enlarging the region by including the selected one or more cells; and (ii) calculating the sum of values of all cells forming the enlarged region.

In one embodiment, the map is a map of two-dimensional space and in another embodiment, the map is a map of three-dimensional space. In another embodiment, the location of one of the one or more initial cells changes with time. In certain embodiments, if the one or more initial cells is two or more initial cells, then one of the two or more initial cells is a first initial cell, and the first region includes the first initial cell and any cells of the plurality of cells disposed between the centroid of the first initial cell and centroids of each of the other initial cells.

In another embodiment, the method further comprises: (i) receiving a threshold value and (ii) selecting initial cells other than said initial cell such that the sum of cell values of all initial cells is equal or greater than the threshold value. In another embodiment, the method further comprises accepting user input of one or more initial cells.

In another aspect, the present teachings provide an apparatus for identifying a region of interest on a map. In one embodiment, the apparatus to produce a map of a mapped region and a target region of interest comprises: (i) computer memory having stored information related to the map, where said information includes information to define a plurality of cells that form the mapped region and a cell value of a plurality of cells, a target value, and the identification of one or more initial cells; (ii) a programmable processor programmed to: (ii)(a) determine a first region, where the first region is contiguous and includes each of the one or more initial cells, and (ii)(b) iteratively enlarge the first region to form a target region by including first-region-adjacent cells to the first region until the sum of the cell values of the first region is equal to or greater than the target value; and (iii) a display to provide a map of at least a portion of the mapped region and the target region.

In one embodiment the stored information includes a criteria value and programmable processor is further programmed to iteratively enlarge the region to form a target region by selecting one or more cells adjacent to the region and having a cell value greater than the criteria value and enlarging the region by including the selected one or more cells and calculating the sum of values of all cells forming the enlarged region. In another embodiment, the stored information includes a threshold value and the programmable processor is programmed to select initial cells other than said initial cell such that the sum of cell values of all initial cells is equal or greater than the threshold value.

In one embodiment, the map produced the apparatus is a map of two-dimensional space and in another embodiment the map is a map of three-dimensional space. In certain embodiments, the location of one of the one or more initial cells changes with time. In another embodiment, if the one or more initial cells is two or more initial cells, then one of the two or more initial cells is a first initial cell, and the first region includes the first initial cell and any cells of the plurality of cells disposed between the centroid of the first initial cell and centroids of each of the other initial cells. In another embodiment, the one or more of the one or more initial cells is user-selected. In yet another embodiment, the target region is a sale territory region.

### BRIEF DESCRIPTION OF THE DRAWINGS

FIGS. 1 A and 1B shows a schematic illustrating a map generating system according to one embodiment of the arrangements.

FIG. 2 shows a process flow diagram for a method, according to one embodiment of the present teachings, for generating a map of multi-dimensional cells.

FIG. 3A shows a geographic region, according to one embodiment of the present teachings and that includes a plurality of cells and a first initial cell.

FIG. 3B shows the geographic region of FIG. 3A, wherein each of the one or more cells has a corresponding cell value.

FIG. 3C shows the geographical region of FIG. 3B and includes the first initial cell and two additional initial cells.

FIG. 4 shows a geographic region, according to another embodiment of the present teachings, and that includes a distance ring.

FIG. 5A shows the geographical region of FIG. 3C, according to one embodiment of the present teachings and that includes a line from the centroid of the first initial cell to each of the additional initial cells.

FIG. 5B shows the geographical region of FIG. 5A and that includes a first region that is contiguous and includes the first initial cell and any cells disposed between the centroid of the first initial cell and centroids of each of the other initial cells.

FIG. 6 shows the geographical region of FIG. 5B and that includes multiple cells adjacent to the first contiguous region.

FIG. 7 shows the geographical region of FIG. 6 and that includes multiple cells adjacent to an enlarged first contiguous region.

FIG. 8 shows the geographical region of FIG. 7 and the target region.

Reference symbols are used in the Figures to indicate certain components, aspects or features shown therein, with reference symbols common to more than one Figure indicating like components, aspects or features shown therein.

### DETAILED DESCRIPTION OF THE PREFERRED EMBODIMENTS

Example embodiments of generating a map to display a region meeting an aggregate target according to the present invention are described. These examples and embodiments are provided solely to add context and aid in the understanding of the invention. Thus, it will be apparent to one skilled in the art that the invention may be practiced without some or all of the specific details described therein. In other instances, well-known concepts have not been described in detail in order to avoid unnecessary obscuring of the present invention. Other applications and examples are possible, such that the following examples, illustrations, and contexts should not be taken as definitive or limiting either in scope or setting. Although these embodiments are described in sufficient detail to enable one skilled in the art to practice the invention, this example, illustrations, and contexts are not limiting, and other embodiments may be used and changes may be made without departing from the spirit and scope of the inventions.

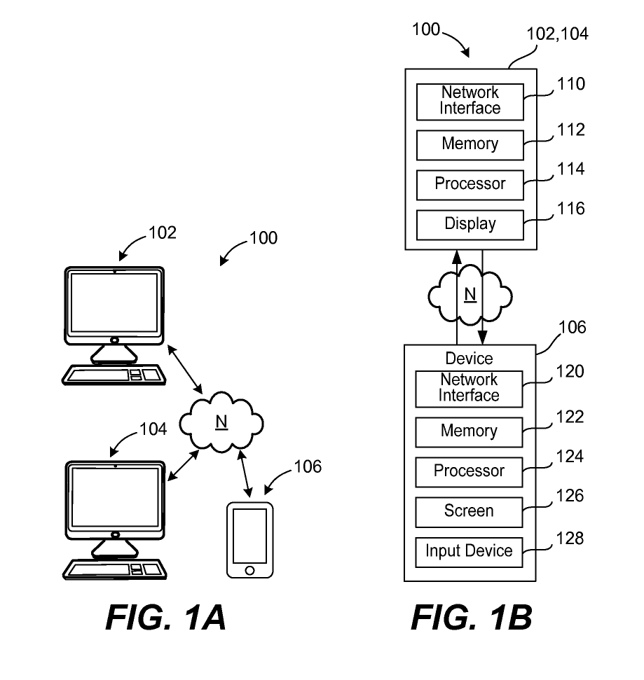

FIGS. 1A and 1B is a schematic, according to one embodiment, of a system 100 for generating a map. In representing physical space, the map is two-dimensional or three-dimensional map, and is referred to, in general, as being multi-dimensional. As shown in FIG. 1A, system 100 includes a first server 102 for computational analysis, one of a plurality of second servers 104 which may host data and an electronic device 106, which communicates over a network N. In one embodiment, device 106 is a wireless device and communicates wirelessly with network N.

First server 102 is a computer or computer system, which includes a network interface 110, a memory 112, a processor 114 and a display 116, as is shown in FIG. 1B. A program, stored in memory 112, may be executed by processor 114 and accept input from electronic device 106 and/or second server 104 through network interface 110 over network N. Processor 114 may also provide output, through network interface 110, to electronic device 106.

Electronic device 106 may be any device that includes a network interface 120, a memory 122, a processor 124, a screen 126 and an input device 128. By way of example, electronic device 106 may be a computer or a mobile device, including but not limited to portable computers, smart phone, or a tablet PC. Network interface 120 may be used by electronic device 106 to communicate over a wireless network, such as a cellular telephone network, a WiFi or WiMax network or BLUETOOTH®. The communication may then transmit through a public switch telephone network, to a satellite, or over the internet. A program, stored in memory 122 and executed by processor 124, may accept inputs (e.g., user input from input device 128) and/or provide output to first server 102 and/or second server 104 over network N. In one embodiment, screen 126 may be a touchscreen and functions as a screen and input device 128.

Servers 104 are computers or computer systems that host data, which may be used by a program on server 102 and/or electronic device 106.

In one embodiment, electronic device 106 generates a map of a multi-dimensional space. A program, running on processor 124, receives inputs from memory 122 and generates a map as an output. A user, using electronic device 106, visualizes the map output on screen 126. In addition to inputs from memory 112, the program may also accept input (e.g., data sets, target values, and/or criteria) from first server 102 and/or second servers 104 over network N. The program may use these inputs to generate and display the map on screen 126.

In another embodiment, first server 102 generates an output—a map of a multi-dimensional space or data that allows a processor on another device to generate a map—and transmits the output to electronic device 106 over Network N. First server 102 may accept inputs from memory 112, second server 104 and/or from electronic device from 106 (e.g., current location of electronic device 126 and/or inputs selected by the user using input device 128). The inputs are processed by a program running on processor 114 to generate an output that is transmitted, over network N, to electronic device 106. The output is displayed to a user on screen 126. If the output is data, processor 124 on electronic device 106 receives the data, generates a map of a multi-dimensional space, and displays the map in screen 126.

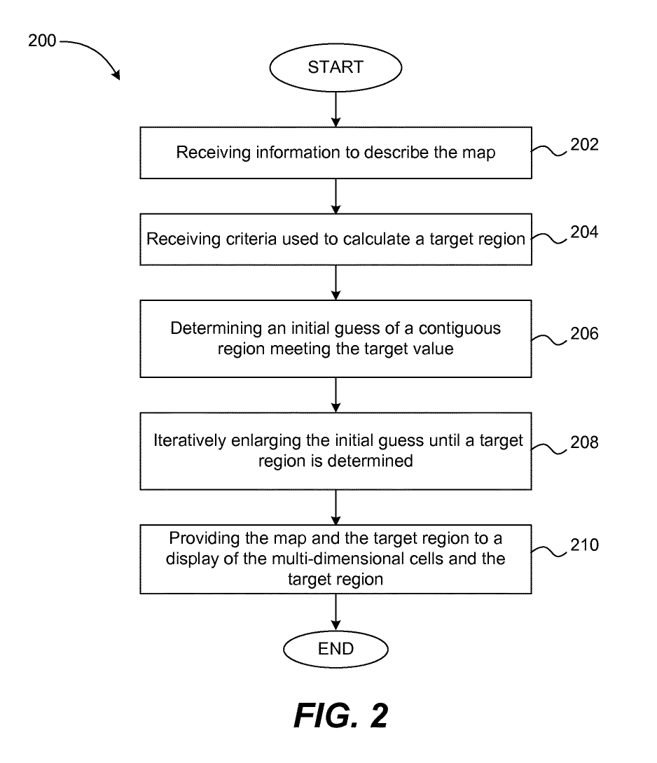

FIG. 2 shows a method 200, according to one embodiment, of producing a map, where each cell of the map has a cell value, and a “target region” (or a “target region of interest”) that includes cells that form a contiguous region and where the sum of all cell values in the target region satisfies an aggregate target value. Preferably, method 200 is performed on system 100, which generates a map and displays the map to a user. Method 200 includes the steps shown in the following Blocks: receiving information to describe the map (Block 202); receiving criteria used to calculate a target region (Block 204); determining an initial guess of a contiguous region meeting the target value (Block 206); iteratively enlarging the initial guess until a target region is determined (Block 208); providing the map and the target region to a display of the multi-dimensional cells and the target region (Block 210).

In method 200, a user provides a user-specified location within the map (which may be, for example and without limitation, a proposed new store location, a proposed home-base for a sales person or a distribution center), and an aggregate target value, and the method determines the target region that is contiguous and which meets the aggregate target value. According to block 202, one step is receiving information to describe the map. In one embodiment, this is accomplished, without limitation by receiving, from memory, information related to the map. The information includes a size of each cell of the plurality of cells, the relative position of each cell of the plurality of cells with respect to at least one other cell of the plurality of cells, and the corresponding cell value with each cell of the plurality of cells. The information related to the map may be obtained from a database of geographical information and/or maybe calculated from such information. Preferably, the information related to the map is stored in memory 122 of electronic device 106.

According to block 204, another step is receiving criteria used to calculate a target region. In one embodiment, this is accomplished, without limitation, by receiving, from memory, a target value, a criteria value, and one or more initial cells, including a first initial cell corresponding to a user-specified location. The target value is any numerical value that, when achieved, instructs the program to end and output a map of a multi-dimensional space. A user may enter the target value or the value may be stored in memory 112 or 122. The criteria value is a minimum value of a cell. Described in greater detail below, the criteria value restricts the cells that may be used in obtaining a target value.

The first initial cell is a user-defined space, or location, and is the basis around which a map is generated. By way of example, in retail the initial first cell may be the geographic location of a new retail store. In yet another embodiment, the initial first cell may be the location of an individual at a particular point in time. In each embodiment, the first initial cell and the multi-dimensional space surrounding the initial first cell is analyzed for generating the map.

Block 206 describes another step that includes determining an initial guess of a contiguous region meeting the target value. In one embodiment, the step includes determining a first region, where the first region is contiguous and includes each of the one or more initial cells The contiguous space represents the core cells of influence and provides a foundation for generating a map of a target region. Those skilled in the art will recognize that there are numerous techniques to determine a contiguous space between the first initial cell and each of the other initial cells. By way of example, a straight line may be drawn between the center point of the first initial cell and the center point of each of the other initial cell. Each cell the line overlaps, between the first initial cell and the other initial cell, is added to the contiguous space.

According to block 208, another step is iteratively enlarging the initial guess until a target region is determined. In one embodiment, this is accomplished, without limitation by iteratively enlarging the first region to form a target region by including first-region-adjacent cells to the first region until the sum of the cell values of the first region is equal to or greater than the target value

If the sum of cell values of all cells in the first region is less than the target value, the embodiment includes finding a target region of interest by selecting one or more cells adjacent to the first region and having a cell value greater than the criteria value. The first region is enlarged by including the selected one or more cells, and the sum of values of all cells forming the enlarged first region is calculated.

Finally, according to block 210, yet another step includes providing a map and the target region to a display of the multi-dimensional cells and the target region. In one embodiment at least a portion of the mapped region and the target region is provided to a display of the electronic device.

### Static Map Generation

In certain embodiments, the location of the first initial cell is stationary (also referred to as “static”). All maps generated using this first initial cell will include that cell within the target region. However, the shape of the multi-dimensional map may change if the input data is different (e.g., cell values changed or changes to the geographic location such as a new competitor). Preferably, the process of generating a map is performed by system 100 having a processor that performs the Blocks described in FIG. 2. The following examples illustrate embodiments with a static first initial cell.

### Determining a Retail Store Location

Process 200 may be used to determine or predict the success of a retail store at a new location. For example, process 200 may be used to generate a map of a contiguous target region (also referred to herein as a “trade area,” or “contiguous trade area”) of a new retail location that reflects the customer base of the new location. The trade area to be determined is the area of best influence to the retail location and, in one example embodiment, represents the majority (e.g., 60% to 85%) of sales. In other words, the trade area is where a user logically understands the extent to which the surrounding area impacts the business.

The trade area map may be two dimensional (e.g., x and y or north-south and east-west) or three-dimensional (e.g., x, y and z or north-south, east-west and elevation). A three-dimensional trade area may be relevant in a geographical area where retail customers are located in multi-floor buildings. A three-dimensional trade area may also be relevant when a user is determining where to locate an establishment in a multi-level building.

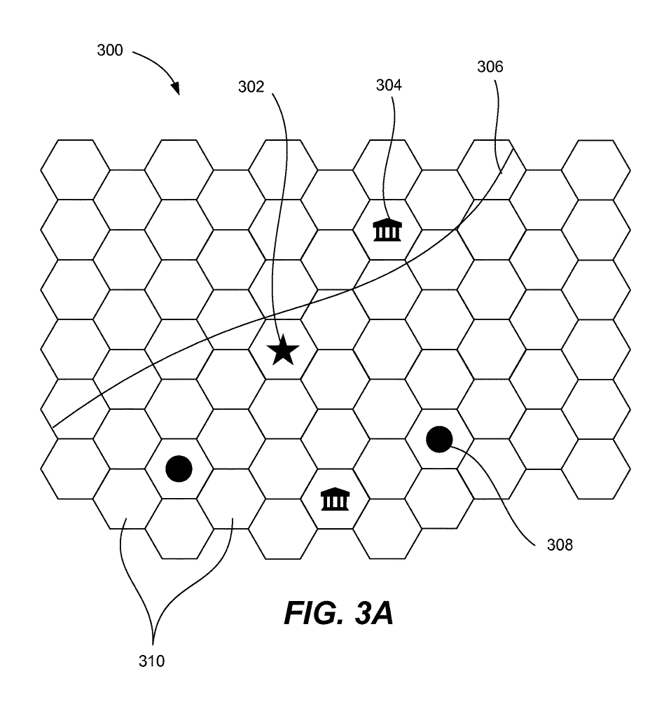

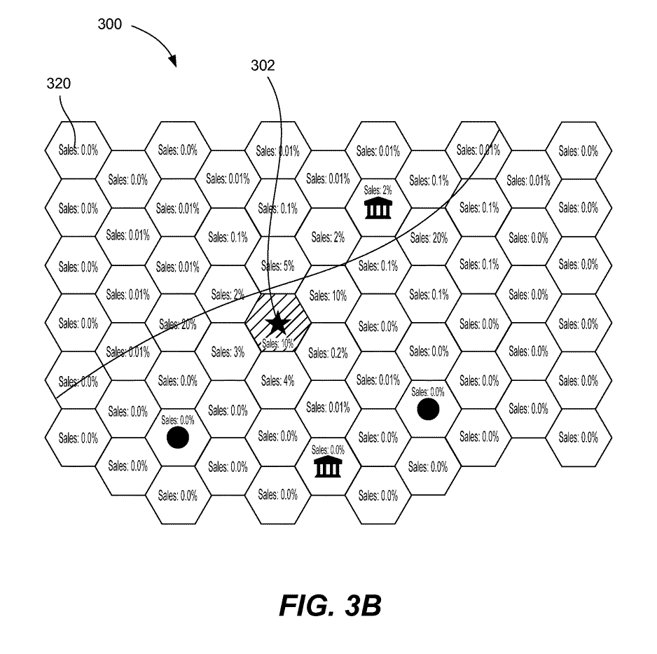

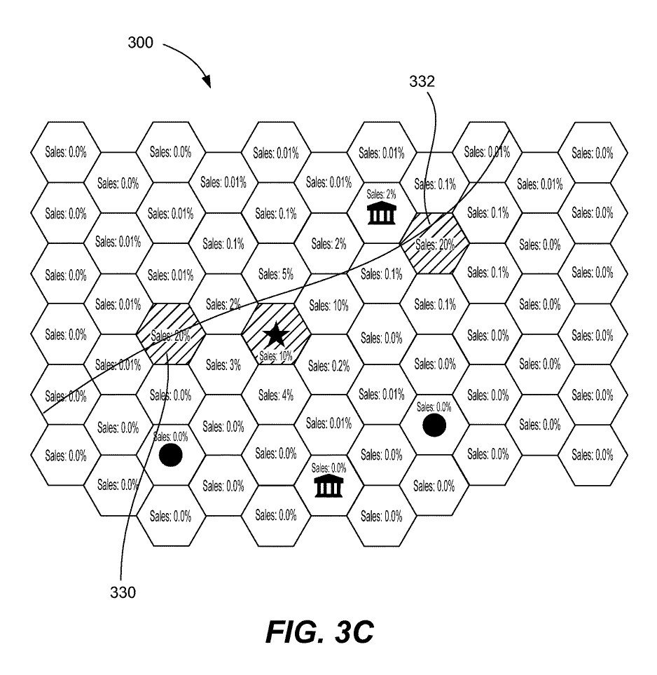

FIG. 3A to FIG. 8 illustrate an exemplar process of generating a map for a retail location. Preferably, a processor (e.g., processor 114 on first server 104 or processor 124 on electronic device 106) of system 100 is programmed to generate the trade area map.

In this example embodiment, processor 114 or 124 is programmed according to method 200 to produce a map of a trade area within a geographic region 300. The program includes a step (e.g., block 202 of FIG. 2) of receiving information to describe the map. The visual representation of the geographic region 300 may be subdivided into a plurality of cells or micro-geographic units 310 that, together, tile region 300. Each cell 310 is a subsection of the geographic location that, in general, may be of any shape and may extend beyond the current view of region 300. If viewed in a visual display, for example, only the first initial cell and cells 310 that fit a display may be shown.

The size and/or shape of each cell 310 of region 300 may vary. For example, in a large city the size of a cell may be a single city block. However, in another region the size and shape of a cell may cover a larger geographic area. In other embodiments, each cell may represent a particular postal zip code or longitude and latitude coordinates. Cell 310 may also include a third component for a three-dimensional x, y and z coordinate system, such as elevation. In one preferred embodiment, as illustrated in FIG. 3A, each cell 310 is hexagonal in shape. In this embodiment, a hexagonal cell 310 touches adjacent hexagonal cells on each of its six sides. This configuration prevents voids between cells 310. In another embodiment, each cell 310 may be adjacent to another cell but not touching cell 310.

FIG. 3B shows geographic region 300 where each cell 310 has a corresponding cell value 320 (e.g., sales percentage) associated with each cell, including the first initial cells 302. Cell value 320 may be any numerical data associated with the corresponding cell that describes a geographic location. In this embodiment, the cell values 320 are sales percentage. However, those skilled in the art of location based forecasting will appreciate that cell value 320 may represent any numerical data that describes a geographic location. For example, the cell value may be, but are not limited to, market share, sales per customer, distance, travel time and income level, a statistical derived index, and Nielsen Rating.

The cell value data may be received from a publicly available database (e.g., U.S. census data, building department's data, department of transportation data) or from data generated by the user or another party. In one preferred embodiment, cell value data is determined by analyzing current retail locations of the same user and/or similar retail businesses. By way of example, a retailer with one thousand retail locations in the United States may analyze a variety of characteristics for each existing retail site such as geography, customer demographics and store sales data. Retail locations with characteristics analogous to the current location are used to predict the sales percentage of each cell of the current geographic location.

Another step (e.g., Block 204 of FIG. 2) of generating a trade area within geographic region 300 is receiving criteria used to calculate a target region. To this end, a processor receives a target value of the trade area of 70%. This input may be received from the memory of first server 104 or electronic device 106 or manually input by a user, for example using input device 128. Also, a criteria value of 1% is received. The criteria value is the minimum cell value of a cell that may be used when enlarging a contiguous region.

The first initial cell and, where applicable, one or more additional initial cells are also received from memory. In this example, the first initial cell is the location of the retail store. The additional initial cells are other locations that the user wishes to be within a target region. Preferably, a user defines the location of the first initial cell. In certain embodiments, the user inputs the location, for example, by inputting an address or geographic coordinates into first server 102 or electronic device 106. In another embodiment, the electronic device 106 determines the geographic location. For example, electronic device may utilize GPS, WI-FI or BLUETOOTH® signals to determine the current location of the electronic device and the proposed retail location.

Referring to FIG. 3A, geographic region 300 shows an identified first initial cell 302. Providing a visual representation of geographical location 300 is not necessary, however, it may assist the user to visually determine the retail location in relation to the surrounding geography. Geographic region 300 also may include natural barriers such as mountains, rivers and valleys and man-made barriers such as parks, major attractions 304 and roadways and streets 306. In certain embodiments, a barrier, natural or manmade, may have cell values that are set to zero because no customers come from the retail store from that location. Similarly, region 300 may also include the location of businesses that are competitors 308 to the user.

In addition to the first initial cell, one or more additional initial cells may also be identified. In one embodiment, the process of identifying additional initial cells includes receiving a threshold value and a minimum cell value. The threshold value is used to determine when a sufficient number of additional initial cells, regardless of the cell location, have been identified. As will be described in greater detail below, if and/or when the threshold value is reached, the process proceeds to step 208 of FIG. 2. In the embodiment describe in FIGS. 3A-8, the threshold value is 40% of total sales.

The minimum cell value is used to select which cells are to be included with the additional initial cells. Only cells with a cell value greater than or equal to the minimum cell value are included. In the embodiment described in FIGS. 3A-8, the minimum cell value is 20% of total sales.

The process of determining one or more additional initial cells, in one embodiment, includes determining if the cell value associated with the first initial cell is less than the threshold value (e.g., 40% of sales). If the value associated with the first initial cell is less than the threshold value, additional initial cells are identified. Referring to FIG. 3B, the sale percentage value of the initial first cell is 10%, which is less than the threshold value of 40%. As a result, the process identifies one or more additional initial cells until the sum of the initial cells are greater than or equal to threshold value.

To identify additional initial cells, any cell with a cell value that is equal to or greater than the minimum cell value is included. As shown in FIG. 3C, two cells—cell 330 and cell 332—each have a value of 20%, which are equal to greater than the minimum cell value of 20%. Therefore, cells 330 and 332 are included as additional initial cells.

Next, the sum of the additional initial cells 330 and 332 and the first initial cell 302 are compared to the threshold value. In the exemplar embodiment, the sum of first initial cells 301 and additional initial cells 330 and 332 is 50%, which is greater than the threshold value of 40%. Thus, the initial cells of are identified as first initial cell 330, and additional initial cells 330 and 332.

In certain instances, however, the sum of the initial cells, including the first initial cell and additional initial cells, is less than the threshold value. Therefore, additional cells may be included until the sum of the cell values of the initial cells is greater than or equal to the threshold value. In one embodiment, any cells that are equal to or greater than a second minimum cell value (e.g., 4% sales) are identified and sorted by cell value from highest to lowest. The highest valued cell is added to the sum of the first initial cell and the values of the additional initial cells and compared to the threshold value. If the sum of cell values is less than the threshold value, the cell with the next highest value is also temporarily added to the sum, which is then compared to the threshold value. This is repeated until the sum is greater than or equal to the threshold value. Thus, each added cell, except the last cell, is included as an additional initial cell.

In another embodiment, additional initial cells are determined by receiving a second minimum cell value (e.g., 4% sales). In addition, each cell receives one or more alternate cell values from data that is different than the original cell value data. The alternate cell value data may be any data that is different than the originally used data (e.g., sales percentage). For example, alternate cell data may be chosen from a group comprising market share, travel time between initial first cell and the identified cell, distance, income index, housing value index, lifestyle characteristic rating, Nielsen ratings (music and/or tv), sales per consumer, density measurements, psychographic measurements, spatial measurements and political affiliations. As a result, each cell may include two or more cell values: sales percentage and one or more alternate values.

In this embodiment, each cell with a corresponding sales percentage value that is greater than or equal to the second minimum value (e.g., 4%) is identified. In addition, an alternate cell value associated with each identified cell is also received. The identified cells are sorted by cell value, from highest to lowest, by alternate cell value. The cell with the highest alternate cell value is selected and the cell's sale percentage value is temporarily added to the sum of the initial cells and compared to the threshold value. In another embodiment, sales percentage value and one or more alternate values of each identified cell are combined (e.g., added or multiplied together) to generate a weighted value. The weighted value of each identified cell is ranked from highest to lowest. The cell with the highest weighted value is selected and the cell's corresponding sales percentage value is temporarily added to the sum of the initial cells and compared to the threshold value.

If the sum of cell values is less than the threshold value, the sales percentage value, corresponding to the second highest alternate cell value or weighted value, is also temporarily added to the sum and compared to the threshold value. The step is repeated until the sum of cell values is equal to or greater than the threshold value. Therefore, each added cell, except the last cell, is included as an additional initial cell.

In another embodiment, the first initial cell is the only identified initial cell and does not include any additional initial cells. By way of example, if the value associated with first initial cell is equal to or greater than the threshold value, method 200 continues such that one or more cells adjacent to the first initial cell meeting the criteria until the sum of the cells is greater than or equal to the target value.

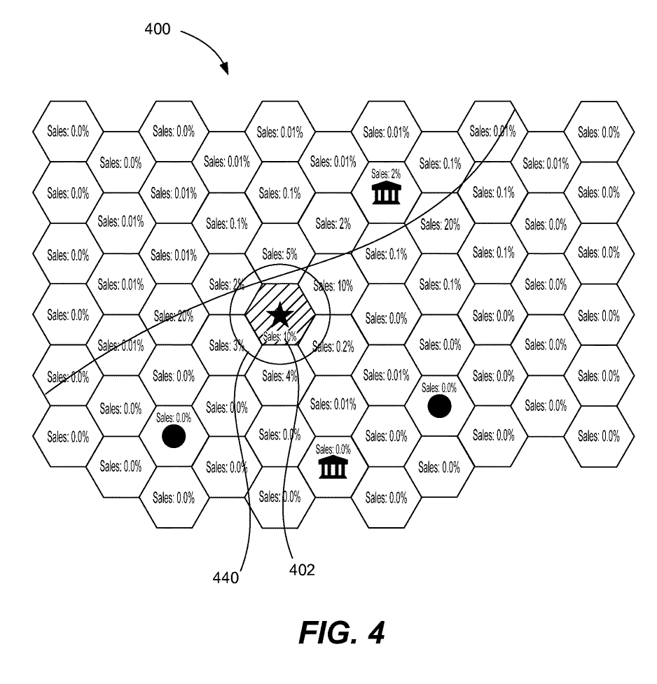

In yet another embodiment, cells adjacent to the first initial cell are identified as one or more additional initial cells. By way of example, FIG. 4 shows a geographic region 400 and first initial cell 402 and may be generally similar to geographic region 300 and first initial cell 302 of FIG. 3, except as further described below. FIG. 4 includes a distance ring 440, having a predetermined diameter and the same center point or centroid the first initial cell 402. Any adjacent cell with a center point that is within distance ring is identified as one or more additional initial cells. The one or more additional cells are added to the first initial cell value and the sum is compared to the threshold value. In FIG. 4, a distance ring is shown around first initial cell 402, however, the centroid of adjacent cells do not fall within the ring. Therefore, each value of each cell is not added to first initial cell.

The distance ring embodiment may be added in geographical areas where there is little activity (e.g., sales) around first initial cell 402. This provides a visual enhancement to the user to prevent vacant zones around the first initial cell 402. However, this may not be advantageous when first initial cell 402 is in close proximity to a physical barrier (e.g., a river) or a psychological barrier (e.g., a safe neighborhood adjacent to a neighborhood with a high rate of crime). The physical or the psychological barrier prevents a potential customer from traveling to first initial cell 402 and therefore it is not desirable to add one or more adjacent cells.

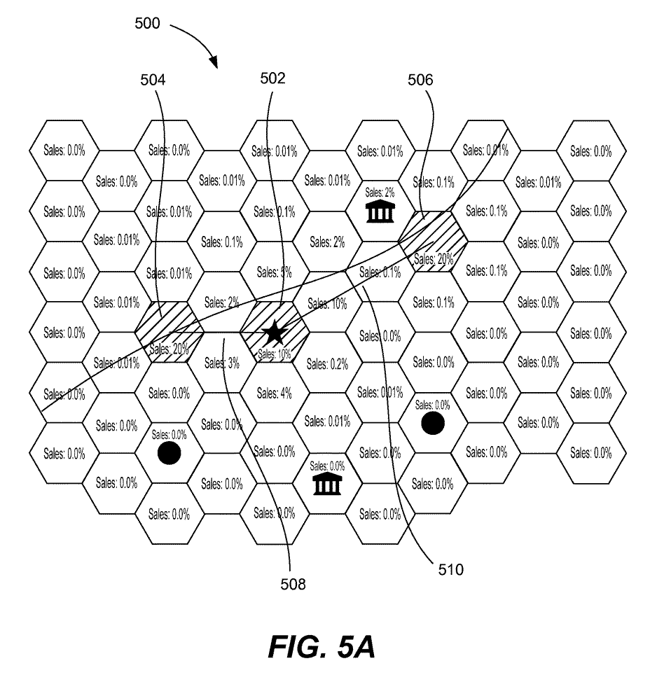

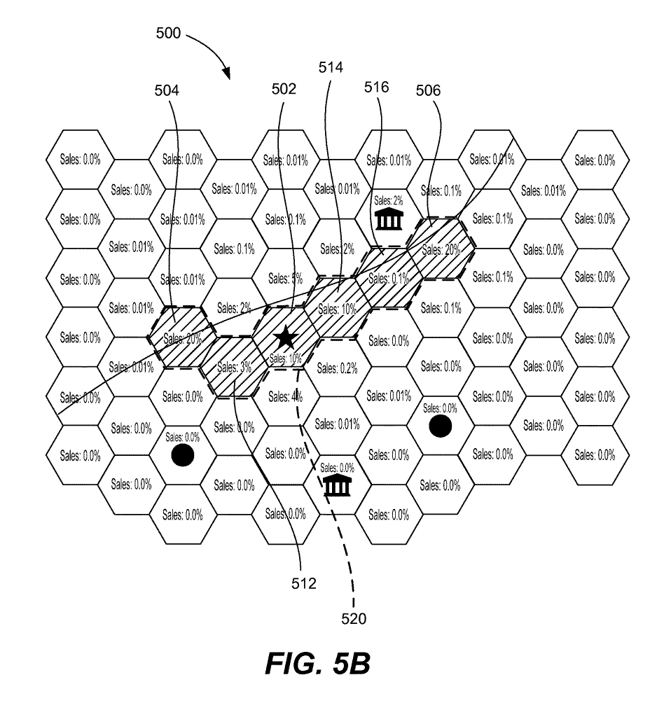

After identifying one or more initial cells, another step (e.g., Block 206 of FIG. 2) of generating a trade area includes determining an initial guess of a contiguous meeting the target value. Then, the sum of values of all cells forming the first region is calculated. FIGS. 5A and 5B shows steps in determining a first region, according to one embodiment. FIGS. 5A and 5B includes a geographic region 500 and first initial cell 502 which are substantially similar to their counterparts in FIG. 3B (e.g., geographic region 300 and first initial cell 302). FIGS. 5A and 5B further include additional initial cells 504 and 506, which may be substantially similar to additional initial cells 330 and 332 of FIG. 3 respectively.

The process of determining a first region begins by generating a layer above geographic location 500 and creating a line from the center point of each additional initial cell to the first initial cell. By way of example, FIG. 5a shows a line 508 between the center points of first initial cell 502 and additional cell 504 and a line 510 is between the center points of first initial cell 502 and additional cell 506.

Each cell that contacts lines 508 and 510 is included to create a contiguous trade area 520. FIG. 5B shows three additional cells 512, 514 and 516 added to the trade area. Contiguous trade area 520 now includes first initial node 502, additional initial nodes 504 and 506 and three additional cells 512, 514 and 516.

Next, the sum of the contiguous first region is calculated and compared to the target value. The target value—70% of projected sales—informs the user where the majority of the sales will come from at the proposed retail location. If the contiguous trade area is equal to or greater than the target value, then a map of the contiguous trade area is outputted to an electronic device (e.g., server 102 or electronic device 106 of FIG. 1). However, if the contiguous trade area is less than the area value, an additional step (e.g., Block 208 of FIG. 2) includes enlarging the contiguous trade area.

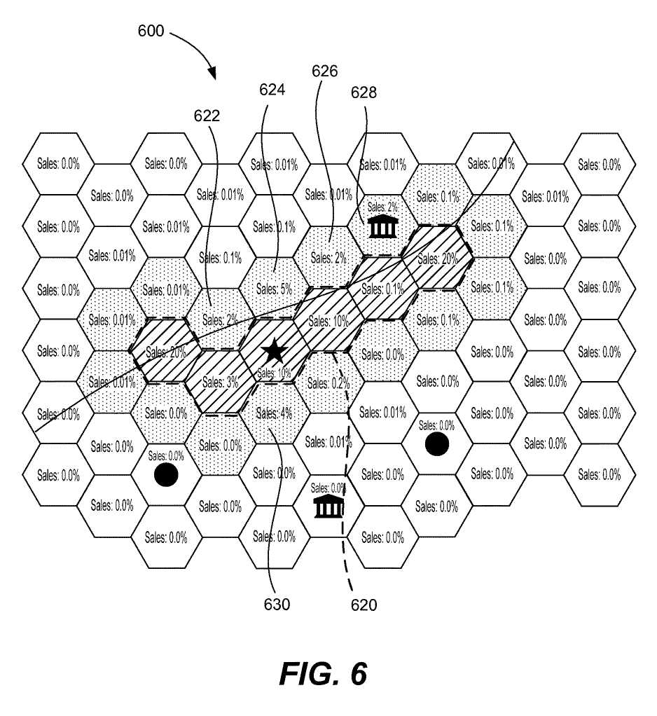

Another step (e.g., Block 208 of FIG. 2) of generating a trade area includes iteratively enlarging the first region until the target value is determined. FIG. 6 shows a geographical region 600, according to one embodiment, having contiguous first region 620 that is substantially similar to geographical region 500 and contiguous first region 520 of FIG. 5B. The sum of contiguous first region 620 is equal to 63.1%, which is less than target value of 70%. Thus, the size of contiguous first region 620 is enlarged until the sum of cell values of contiguous first region 620 is greater than or equal to the target value. To enlarge contiguous first region 620, all cells touching contiguous first region 620 and having a cell value greater than or equal to the criteria value are selected. In this exemplar embodiment the criteria value is 1%. As shown in FIG. 6, multiple cells (e.g., cells shown in lighter grey) are touching the contiguous first region 620. Cells 622, 624, 626, 628 and 630, however, are the only cells that are touching the contiguous area and have a cell value that is greater than or equal to the criteria value of 1%.

In certain embodiments cells 622, 624, 626, 628 and 630 are added to the contiguous first region 620 to generate an enlarged first region. However, in preferred embodiments, cells 622, 624, 626, 628 and 630 are filtered to include only the cell or cells with the highest cell value. For example, cells 622, 624, 626, 628 and 630 may be sorted and ranked by the cell value, sales percentage. As shown in FIG. 6, the cell with the highest cell value is cell 624, with 5% projected sales, and is it added to the contiguous first region.

However, the cell ranking may also be coupled to alternate cell value data or a weighted value combining the sale percentage value and one or more alternate values. Ranking the cells based on an alternate value or weighted value may be used when the cell values of each cell are substantially similar. Thus, a target contiguous region includes alternate data, in addition to sale percentage, that is important to the user.

In this exemplar embodiment, the cell with the highest cell value is included in contiguous first region 620 and the sum of the enlarged contiguous first region is calculated. If the sum of the enlarged contiguous first region value is greater than or equal to the 70% threshold value, the generation of a target region is determined and the program stops. If, however, the sum of the enlarged contiguous trade area value is less than the 70% threshold value, enlarged contiguous trade area 620 is iteratively enlarged (e.g., repeating Block 206 of FIG. 2).

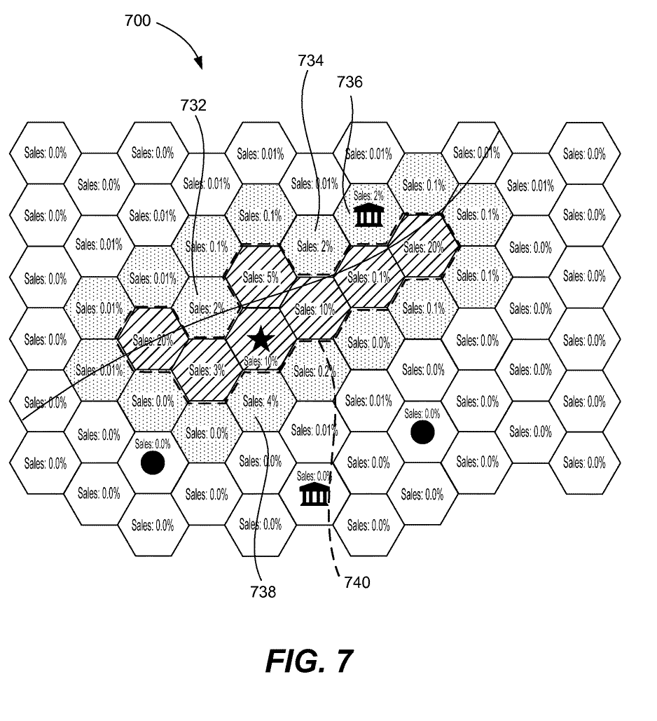

FIG. 7 shows a geographical region 700 with an enlarged contiguous first region 740 that is substantially similar to geographical region 600 of FIG. 6,except as explained below. Geographical region 700 includes enlarged trade area 740 that includes an added cell (e.g., cell 624 of FIG. 6). The sum of cell values of the cells of enlarged contiguous first region 740 is 68.1%, which is less than the target value of 70%. Thus, enlarged contiguous first region 740 is enlarged again. Cells 732, 734, 736 and 738 have minimum cell value of 1% and are touching contiguous trade area 740. Ranked by cell value from highest value to lowest, cell 738, with 4% of sales, has the highest cell value. Cell 738 is temporarily added to sum of enlarged first region 740 and compared to the target value of 70%. In this example, adding cell 738 would generate an enlarged first region at 72.1%, which is over the target trade area value of 70%. Cell 738, therefore, is excluded and the process of including additional cells into enlarged first region 740 is complete.

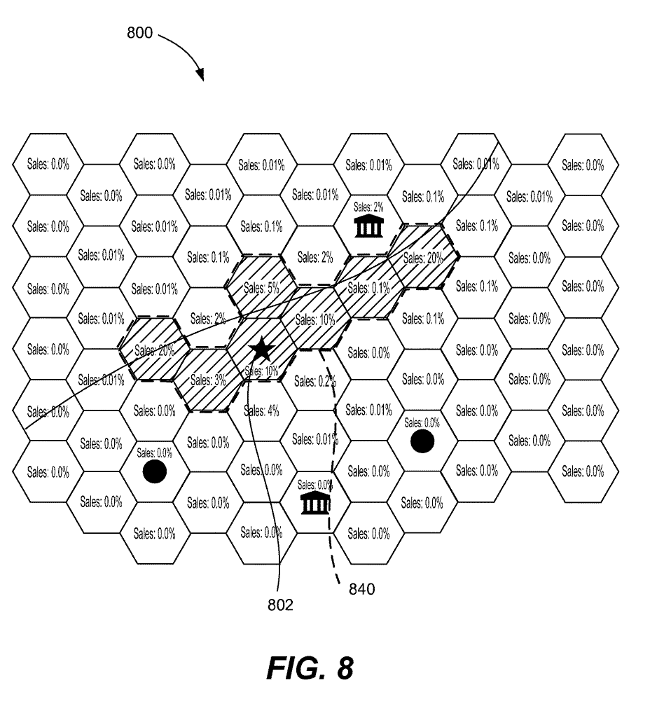

FIG. 8 is geographic region 800, according to one embodiment, showing a target region 820 for a retail store located at first initial cell 802. Target region 820 includes 68.1% of the projected sales the retail store. Contiguous target region may then be displayed on an electronic device as shown in Block 210 of FIG. 2.

### Determining a Territory Size

When selling a product or service, it is often difficult to determining the size of a territory for a product or service to ensure the sales are successful. If a business entity selects a territory that is too small, the business ignores potential customers outside of the territory. If the selected territory is too large, the business may not be able to service all the potential customers within the territory. As a result, potential sales are neglected. In a territory that is too large or too small, the individual or business overlooks potential sales. Therefore, it is critical to determine a territory size that maximizes the businesses entity expectation of success.

The process of generating a map of a multi-dimensional space may be used to determine the size of a territory to support the successful sale of a product or service. In one embodiment, method 200 may be used on system 100 to create a territory size with the highest likelihood of success but not so large that the territory cannot be serviced well. By way of example, a franchisee of a national mobile cleaning service intends to open a franchise in a new market. Before the franchise opens, however, the franchisee needs to determine a territory size, which includes 70% of potential sales, for the new franchise. Franchisee may use method 200 on system 100 to generate a map of a contiguous territory that includes 70% of the franchisee's potential sales. Process 200 uses data from other franchise locations nationwide and the new market to determine the contiguous territory for the new market. Franchisee may then use this information to execute a business strategy, for example, determining where to target advertising, how many employees to hire or how many vehicles are necessary to cover the territory.

### Determining Where to Use a Sales Force to Support a Product

Many business entities sell a product or service nationwide where the sales are dispersed across the country. If a contiguous trade area is generated. It may be difficult to determine which markets a sales force should target. Business entities may not want or have the resources to direct a sales force supporting sales throughout the entire country. Rather the business entities may be interested in focusing on markets with a large concentration of potential customers and directing a sale force to those markets. However, it may be difficult to determine which markets the sales force should target if each market is isolated from each other.

Method 200 and/or system 100 may be used to determine the isolated markets—or micro trade area—that include a large percentage of the business entity's sales and then generate a contiguous trade area within each micro trade area. By way of example, a windsurfing company located in Seattle Washington has sales throughout the country but has a limited sales staff. The company needs to know where to target the sales staff to support the their products. The company first determines the micro trade areas that account for a large percentage of the company's sale. In one embodiment, the company may use the step (e.g., step 206 of FIG. 2) of identifying one or more initial cells including the first initial cell (Seattle, Wash.) and one or more additional initial cells. The additional initial cells may be filtered to only include cells have a high sales percentage (e.g., a minimum cell value of 10%).

The process of identifying additional initial cells shows the company that a large percentage of sale are located in cells that include cities that have adjacent lakes, large rivers and oceans. The company may then generate a map of a contiguous trade area or territory for the first initial cell and for each of the additional cell. The company may then direct its sales force to target only the contiguous trade area or territory with each cell.

### Determining the Likelihood of Success for a Band

A band or record label often has difficulty determining which venues a band should play in to build a fan base and untimely become a successful band. The band, playing in venues with a crowd that shows no interest in the music, may not develop a fan base quickly enough to be successful. Conversely, if a band plays in venues with a highly engaged crowd, the band may quickly develop a fan base. Therefore, it is important to find venues where the crowd will have an interested and support the band.

To determine if a venue will support a band, the band or record label may use the process of producing a map of contiguous multi-dimensional space. For example, the crowd reaction to a band or each song of the band is analyzed in each venue where the band previously played. In addition, the demographics of the crowd for each venue are analyzed (e.g., age, sex, distance from venue, income level, etc.) and together with the crowd reaction, a crowd profile is generated. At each proposed new venue, the process of generating a contiguous map is performed to determine if the crowd profile equals or exceeds a threshold value that is high enough to support a particular band.

For example, a record label may determine a particular band, band “A”, must have a crowd profile threshold value of 80 point or more. If the crowd profile is less than 80, band A will not play at the venue. A processor receives information about the cells of a new geography, including the value of each cell. Preferably, the processor identifies crowd profiles with demographics similar to the demographics of the current venue to determine the cell value of each cell. Next, a first contiguous region, which includes a first initial cell, where the venue is located, is determined. If the sum the first contiguous region is less than the threshold value of 80, a target region is determined by adding additional cells to form an enlarged first region. If the threshold value of the target region is less the 80, the venue does not have a crowd profile that high enough to support band A and record label may look for other venues or other cities for band A to perform.

### Dynamic Map Generation

In certain embodiment of the present invention, a space (e.g., location of interest) is dynamic or moving rather than static. For example, an additional dimension—time—may be combined with space to determine a location. Thus, the process of generating a map of a multi-dimensional space also includes time. If the location of interest changes as a function of time, the map of a multi-dimensional space is different than the previous map. The embodiments described provide an example of dynamic map generation.

### Detecting Danger in a Military Setting

In a military setting, such as a battlefield, a soldier may encounter potentially dangerous situations that cause injury or death to the soldier or others nearby. However, the military unit or the soldier may be unable to detect or predict the location of the potential danger as the soldier moves around the battlefield. The ability to predict the location of a potential danger provides the soldier with critical information that he or she can use to maneuver around the potential danger.

The process of generating a map of a multi-dimensional space may be used to alert a soldier on a battlefield of the likelihood of a dangerous situation (e.g., an Improvised Explosive Device or IED). By way of example, in one embodiment, method 200 of FIG. 2 continuously runs as a soldier moves through a battlefield. At each instance process 200 executes, data from prior IED attacks and characteristics of the current location are used to determine likelihood an IED attack nearby. As a soldier is walking down a street, he or she may be alerted if there are nearby cells with a high likelihood (e.g. a 40% chance) of an IED (hereinafter also known as “hot cells”). The soldier is shown a map with hot cells relative to the soldier's current location. With this information, the soldier can then adjust his or her route to an area where there is a lower probability of an IED explosion.

In the embodiments described above, the multi-dimensional cells are located by way of distance or length. However, the invention is not so limited. In other embodiments, multi-dimensional space may be measured as sound, time, speed, height, depth, width, radiography, quantum communication, doppler shift, size of body, density, subjective ranking, psychographics ranking and telemetry.

One embodiment of each of the methods described herein is in the form of a computer program that executes on a processing system, e.g., one or more processors that are part of a networked system. Thus, as will be appreciated by those skilled in the art, embodiments of the present invention may be embodied as a method, an apparatus such as a special purpose apparatus, an apparatus such as a data processing system, or a carrier medium, e.g., a computer program product. The carrier medium carries one or more computer readable code segments for controlling a processing system to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code segments embodied in the medium. Any suitable computer readable medium may be used including a magnetic storage device such as a diskette or a hard disk, or an optical storage device such as a CD-ROM.

It will be understood that the steps of methods discussed are performed in one embodiment by an appropriate processor (or processors) of a processing (e.g., computer) system executing instructions (code segments) stored in storage. It will also be understood that the invention is not limited to any particular implementation or programming technique and that the invention may be implemented using any appropriate techniques for implementing the functionality described herein. The invention is not limited to any particular programming language or operating system.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner, as would be apparent to one of ordinary skill in the art from this disclosure, in one or more embodiments.

Similarly, it should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Thus, while there has been described what is believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention

Although illustrative embodiments of the present teachings and arrangements have been shown and described, other modifications, changes, and substitutions are intended. Accordingly, it is appropriate that the appended claims be construed broadly and in a manner consistent with the scope of the disclosure, as set forth in the following claims.

What is claimed is:

1. A method for producing a map of a mapped region and a target region of interest, said method comprising:
receiving, in the memory of an electronic device, information to define a plurality of cells that form the mapped region and a cell value of a plurality of cells, a target value, and the identification of one or more initial cells;
determining, in a processor of the electronic device, a first region, where the first region is contiguous and includes each of the one or more initial cells;
iteratively enlarging the first region to form a target region by including first-region-adjacent cells to the first region until the sum of the cell values of the first region is equal to or greater than the target value; and
providing at least a portion of the mapped region and the target region to a display of the electronic device.

2. The method of claim 1, wherein
receiving includes receiving a criteria value; and wherein
iteratively enlarging the region to form a target region includes:
selecting one or more cells adjacent to the region and having a cell value greater than the criteria value;
enlarging the region by including the selected one or more cells; and
calculating the sum of values of all cells forming the enlarged region.

3. The method of claim 1, wherein the map is a map of two-dimensional space.

4. The method of claim 1, wherein the map is a map of three-dimensional space.

5. The method of claim 1, wherein the location of one of the one or more initial cells changes with time.

6. The method of claim 1, where, if the one or more initial cells is two or more initial cells, then one of the two or more initial cells is a first initial cell, and the first region includes the first initial cell and any cells of the plurality of cells disposed between the centroid of the first initial cell and centroids of each of the other initial cells.

7. The method of claim 1, further comprising:
receiving a threshold value; and
selecting initial cells other than the initial cell such that the sum of cell values of all initial cells is equal or greater than the threshold value.

8. The method of claim 1, further comprising:
accepting user input of one or more initial cells.

9. The method of claim 1, where the target region is a sale territory region.

10. An apparatus to produce a map of a mapped region and a target region of interest, said apparatus comprising:
computer memory having stored information related to the map, where the information includes information to define a plurality of cells that form the mapped region and a cell value of a plurality of cells, a target value, and the identification of one or more initial cells; and
a programmable processor programmed to:
determine a first region, where the first region is contiguous and includes each of the one or more initial cells, and
iteratively enlarge the first region to form a target region by including first-region-adjacent cells to the first region until the sum of the cell values of the first region is equal to or greater than the target value; and
a display to provide a map of at least a portion of the mapped region and the target region.

11. The apparatus of claim 10, wherein the stored information includes a criteria value; and
wherein the programmable processor is further programmed to iteratively enlarge the region to form a target region by: selecting one or more cells adjacent to the region and having a cell value greater than the criteria value and enlarging the region by including the selected one or more cells; and calculating the sum of values of all cells forming the enlarged region.

12. The apparatus of claim 10, wherein the map is a map of two-dimensional space.

13. The apparatus of claim 10, wherein the map is a map of three-dimensional space.

14. The apparatus of claim 10, wherein the location of one of the one or more initial cells changes with time.

15. The apparatus of claim 10, where, if the one or more initial cells is two or more initial cells, then one of the two or more initial cells is a first initial cell, and the first region includes the first initial cell and any cells of the plurality of cells disposed between the centroid of the first initial cell and centroids of each of the other initial cells.

16. The apparatus of claim 10, where the stored information includes a threshold value; and
where the programmable processor is programmed to select initial cells other than the initial cell such that the sum of cell values of all initial cells is equal or greater than the threshold value.

17. The apparatus of claim 10, wherein one or more of the one or more initial cells is user-selected.

18. The apparatus of claim 10, where the target region is a sale territory region.
